(19) United States
(12) Patent Application Publication
(10) Pub. No.: US 2009/0151248 A1
(43) Pub. Date: Jun. 18, 2009

(54) DEVICES AND METHODS FOR GROWING PLANTS

(75) Inventors: W. Michael Bissonnette, Boulder, CO (US); Brett Pardikes, Arvada, CO (US); Terry Robertson, Boulder, CO (US); Brian McGee, Firestone, CO (US); John Thompson, Niwot, CO (US); Sylvia Bernstein, Boulder, CO (US); Dan Lovato, Thornton, CO (US); Mica Gross, Lafayette, CO (US)

Correspondence Address: VENABLE LLP, P.O. BOX 34385, WASHINGTON, DC, 20043-9998, US

(73) Assignee: AEROGROW INTERNATIONAL, INC., Boulder, CO (US)

(21) Appl. No.: 12/261,821

(22) Filed: Oct. 30, 2008

Related U.S. Application Data
(60) Provisional application No. 61/000,926, filed on Oct. 30, 2007.

(51) Int. Cl. A01G 31/00

(52) U.S. Cl. 47/59 S; 47/62 R

(57) ABSTRACT

A countertop gardening appliance can include a base sized and dimensioned to fit on a countertop, a vessel removably supported by the base, the vessel defining a closed lower portion for storing a liquid, and an open upper portion, a gas diffuser located in the vessel, a gas pump located within the base, a conduit connecting the gas pump to the gas diffuser, a one-way valve in fluid communication with the conduit, a growing surface covering the open upper portion of the vessel, the growing surface including a receptacle adapted to receive a seed cartridge, a liquid level gauge indicating a level of the liquid in the vessel, a hood supported above the growing surface by a support arm connected to the base, the hood including an artificial light source, and a controller located within the base, the controller adapted to activate the artificial light source and the gas pump on predetermined time cycles.

### CROSS-REFERENCE TO RELATED APPLICATIONS

This application claims priority under 35 U.S.C. § 119(e) to U.S. Provisional Patent Application No. 61/000,926, filed on Oct. 30, 2007, the entire content of which is expressly incorporated herein by reference.

### BACKGROUND

1. Technical Field

The present invention relates generally to indoor gardening appliances, and more specifically, to countertop-sized hydroponic and aeroponic gardening appliances.

2. Related Art

Hydroponics and aeroponics involve the cultivation of plants without soil. Instead of soil, the plants are cultivated in a liquid solution of water and nutrients. For example, in typical hydroponic systems, plants are grown with their roots submerged in the liquid solution. In typical aeroponic systems, the plants are cultivated with their roots suspended freely above the liquid solution; periodically, the roots are exposed to a spray, forced mist, fog or other method of nutrient solution delivery. Hydroponic and aeroponic systems typically provide healthier, disease-free plants, more quickly than growing in soil.

Known hydroponic and aeroponic systems have been designed for large-scale agriculture. These systems typically do not work for a retail consumer, because they can be expensive, large, unsightly, complicated, and/or can require extensive maintenance. In addition, consumers typically have different goals compared to large-scale agriculture (e.g., the consumer's concern for harvest quality greatly outweighs their concern for production quantity).

In view of the foregoing, there remains a need for devices and methods for growing plants that overcome the shortcomings of the prior art.

### SUMMARY

According to an illustrative embodiment, a countertop gardening appliance can comprise a base sized and dimensioned to fit on a countertop, a vessel removably supported by the base, the vessel defining a closed lower portion for storing a liquid, and an open upper portion, a gas diffuser located in the vessel, a gas pump located within the base, a conduit connecting the gas pump to the gas diffuser, a one-way valve in fluid communication with the conduit, a growing surface covering the open upper portion of the vessel, the growing surface including a receptacle adapted to receive a seed cartridge, a liquid level gauge indicating a level of the liquid in the vessel, a hood supported above the growing surface by a support arm connected to the base, the hood including an artificial light source, and a controller located within the base, the controller adapted to activate the artificial light source and the gas pump on predetermined time cycles.

According to another illustrative embodiment, a countertop gardening appliance can comprise a base sized and dimensioned to fit on a countertop, a vessel removably supported by the base, the vessel defining a closed lower portion for storing a liquid, and an open upper portion, a gas diffuser located in the vessel, a gas pump located within the base, a conduit connecting the gas pump to the gas diffuser, a growing surface covering the open upper portion of the vessel, the growing surface including a receptacle adapted to receive a seed cartridge, and a fluid coupling in fluid communication with the conduit, the fluid coupling including a first portion located on the base and a second portion located on a bottom wall of the vessel, wherein the first portion of the fluid coupling and the second portion of the fluid coupling interconnect when the vessel is supported on the base, and the first portion of the fluid coupling and the second portion of the fluid coupling disconnect when the vessel is removed from the base.

### BRIEF DESCRIPTION OF THE DRAWINGS

The foregoing and other features and advantages of illustrative embodiments of the present invention will be apparent from the following detailed description, as illustrated in the accompanying drawings, wherein like reference numbers generally indicate identical, functionally similar, and/or structurally similar elements.

FIG. 1A is a perspective view of a countertop gardening appliance according to an illustrative embodiment of the present invention;

FIG. 1B is a perspective view of an illustrative seed cartridge for use in the countertop gardening appliance of FIG. 1A;

FIGS. 2A-2D are a front, rear, left side, and right side view, respectively, of the countertop gardening appliance of FIG. 1A;

FIGS. 3A and 3B are a top view and a bottom view, respectively, of the countertop gardening appliance of FIG. 1A;

FIG. 4 is a front view of the countertop gardening appliance of FIG. 1A, shown with a hood in a raised position;

FIG. 5 is a front view of a countertop gardening appliance according to another illustrative embodiment of the present invention;

FIG. 6 is a rear perspective view of the countertop gardening appliance of FIG. 5;

FIGS. 7A and 7B are a perspective view and a front view, respectively, of a countertop gardening appliance according to another illustrative embodiment of the present invention;

FIGS. 8A-8D are a perspective view, a top view, a front view, and a back view, respectively, of an illustrative vessel of the countertop garden of FIG. 1A;

FIG. 9 is a perspective view of an illustrative base, support arm, and hood of the countertop gardening appliance of FIG. 1A;

FIG. 10 is a perspective view of an interior portion of the vessel of the countertop gardening appliance of FIG. 1A;

FIG. 11 is a side, sectional view of a lower portion of the countertop gardening appliance of FIG. 1A, showing some of the internal components of the appliance;

FIGS. 12A and 12B are a perspective view, and a top view, respectively, of an illustrative frame of the seed cartridge of FIG. 1B;

FIG. 13A is a perspective view of the underside of the hood of the countertop gardening appliance of FIG. 1A, shown with the light bulb removed;

FIG. 13B is a bottom view of the hood of FIG. 13A, shown with light bulb installed;

FIG. 14 is a perspective view of a base and vessel of FIG. 6, showing an illustrative inverted p-trap in an interior portion of the vessel;

FIG. 15 is perspective sectional view of the vessel of FIG. 14, shown removed from the base;

FIG. 16 is a perspective view of the base of FIG. 14, shown with the vessel removed;

FIG. 17 is an enlarged, partial sectional view of a fluid coupling between the vessel and the base of FIG. 14;

FIG. 18 is a side, sectional view of the base and vessel of FIG. 1A;

FIG. 19 is a perspective view of the base and vessel of FIG. 18, showing an illustrative inverted p-trap located in an interior of the vessel;

FIG. 20 is a perspective view of an illustrative growing surface for the countertop gardening appliance of FIG. 5;

FIG. 21 is a partial, side, sectional view of the growing surface of FIG. 20; and

FIG. 22 is a partial sectional view of a countertop gardening appliance according to the present invention, shown with a plant growing from one of the seed cartridges.

### DETAILED DESCRIPTION

Illustrative embodiments of the present invention are discussed in detail below. In describing the embodiments, specific terminology is employed for the sake of clarity. However, the invention is not intended to be limited to the specific terminology so selected. While specific embodiments are discussed, it should be understood that this is done for illustration purposes only. A person skilled in the relevant art will recognize that other components and configurations can be used without departing from the spirit and scope of the invention.

As used in the art and as used herein, “nutrients” refers to atoms and molecules in an available from necessary for plant growth in addition to oxygen, hydrogen, and water including calcium, magnesium, sodium, potassium, nitrogen, phosphorus, sulfur, chlorine, iron, manganese, copper, zinc, boron, and molybdenum. Nutrient formulations and recipes are known in the art. As used herein, “photoradiation” refers to wavelengths of light of sufficient quantity and quality that allow a plant to grow, as is known in the art.

The term “growing a plant” as used herein refers to the process which takes place when appropriate conditions such as water, photoradiation, gas containing oxygen and carbon dioxide, and nutrients are provided to a plant tissue, whether a seed, a cutting, transplant, bulb, tuber, runner, or a plant having roots, resulting in an increase in the mass of plant tissue. The term “cutting” as used herein refers to plant tissue with or without roots taken from an already existing plant.

The term “germinating a seed into a plant” as used herein refers to the process which takers place when appropriate conditions such as water, photoradiation, gas containing oxygen, carbon dioxide and optionally nutrients are provided to the seed, resulting in the emergence of a plant embryo from the seed.

The term “growth medium” as used herein refers to any material which permits the growth of plant material or the germination of a seed to take place. Soil-less media for growing plants are generally composed of materials that have moderate water-retention characteristics, allowing liquid nutrient solution to flow readily to plant roots and then to drain away so that roots are not constantly soaked in a liquid that may foster rot or the growth of damaging fungi. Soil-less media may be composed of any number of suitable porous substances, as is known in the art, such as peat moss, wood bark, cellulose, pumice, clay pellets, vermiculite or foam, for example.

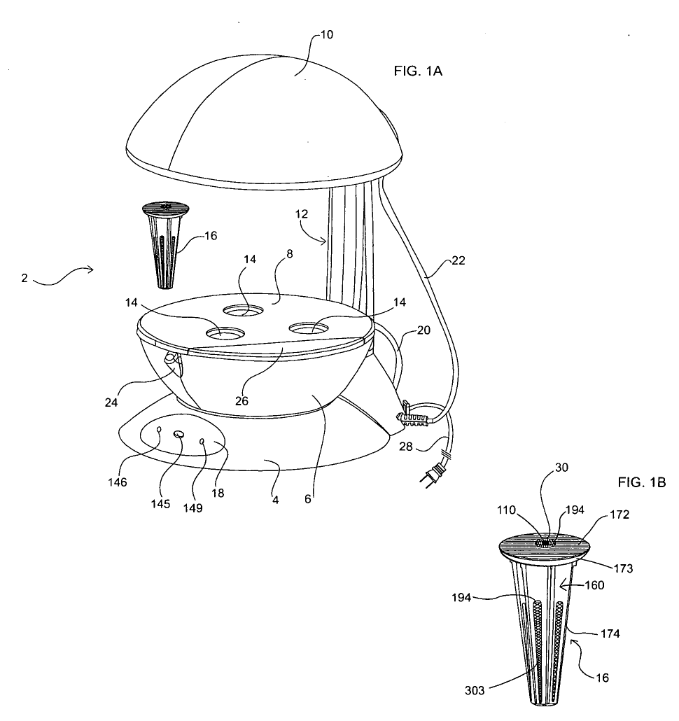

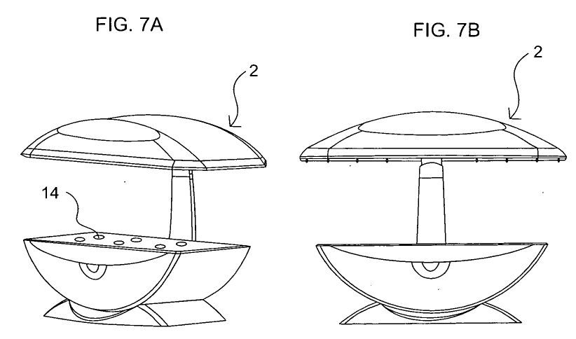

Referring to FIG. 1A, an illustrative countertop gardening appliance 2 according to the present invention is shown. The appliance 2 can be self-contained, and can provide water, photoradiation, and/or plant nutrients to one or more seeds or plants with little care or maintenance by a user. As shown in FIG. 1A, the appliance 2 can generally include a base 4, a vessel 6 removably supported on top of the base 4, a growing surface 8 covering the vessel 6, and a photoradiation hood 10 supported above the growing surface 8, for example, by an extendable support arm 12. The photoradiation hood 10 can include one or more light artificial light sources, such as light bulbs (hidden from view). The growing surface 8 can include one or more receptacles 14 for receiving a seed cartridge 16, shown in more detail in FIG. 1B. The illustrative embodiment of FIG. 1A shows three receptacles 14 in the growing surface 8, however, the appliance 2 is not limited to any specific number of receptacles 14. That is, various embodiments of the invention can have one or more receptacles 14 in the growing surface 8. FIGS. 6, 7A, and 7B depict illustrative embodiments having six receptacles 14. The various components and features described herein can be used interchangeably with the various appliances 2 shown and described herein, such as, for example, the three cartridge garden shown in FIG. 1A, the six cartridge gardens shown in FIGS. 5-7.

Referring back to FIG. 1A, the appliance 2 can also include a control panel 18, a controller, and a gas pump. As shown in the illustrative embodiment of FIG. 1A, the controller and gas pump can be wholly located in the interior of the base 4, and hence hidden from view. The control panel 18 and the controller can comprise a single unit, or alternatively, can comprise two or more separate components. The gas pump can deliver a supply of gas, such as oxygen, to a liquid contained in the vessel 6, for example, via a conduit 20, shown in FIG. 1A as a tube, extending from the pump to the interior of the vessel 6, as will be discussed in more detail later.

In use, a user can use the control panel 18 to select a predetermined timing cycle tailored to the type of seeds or plants contained in the seed cartridges 16. The timing cycle can include a timed on/off cycle for the light bulb(s) in the photoradiation hood 10, and/or a timed on/off cycle for the gas pump contained in the base 4. The controller can then turn the light bulb(s) in the photoradiation hood 10 on and off based on a timed cycle, for example, by controlling the electrical current delivered from electrical conduit 22. Additionally or alternatively, the controller can turn the gas pump in base 4 on and off based on the timed cycle, for example, by controlling an electrical current sent to the gas pump. The timed cycle for the gas pump and the timed cycle for the light bulb(s) can be the same, or can be different from one another. The illustrative control panel 18 shown in FIG. 1A can include an add nutrient indicator 146, an on/off or reset button 145, and/or a replace bulb indicator 149, however, other configurations are possible. According to an illustrative embodiment, the appliance 2 can include a backup battery to maintain operation of the controller during short time intervals in which electricity is not supplied, such as during power outages or during transport of the appliance 2 to a different location.

Still referring to FIG. 1A, the appliance 2 can further include a liquid level gauge 24 that extends into the vessel 6 and indicates the level of a liquid (not shown) container within a closed lower portion of the vessel 6. The liquid level gauge 24 can be configured to indicate when the liquid level within the vessel 6 has decreased below a minimum liquid level (e.g., the lowest level at which the appliance 2 will function properly, or the greatest distance between the liquid and the lowermost portion of the growing medium 194 at which the growing medium 194 is unlikely to dry out before a user of the appliance 2 notices that the liquid level is below the minimum liquid level). The liquid level gauge 24 can change colors when the liquid level falls below the minimum liquid level, although other configurations are possible, as will be discussed in more detail below.

The appliance 2 can also include a door 26 through a portion of the growing surface 8 or vessel 6 to provide access to the interior of the vessel 6, for example, to introduce liquid and/or nutrients into the vessel 6. The appliance 2 can also include a power cord 28, for example, to connect the controller and other electrical components to a power source, such as a conventional 110V AC household outlet.

Alternative embodiments of the present invention can provide simplified versions of the appliance 2. For example, according to an illustrative embodiments, the appliance 2 can be provided without, for example, the photoradiation hood 10, the liquid level gauge 24, the control panel 18, and/or the controller. Accordingly, one of ordinary skill in the art will appreciate that the appliance 2 is not limited to any specific combination or arrangement of the components described herein.

Referring to FIG. 1B, an illustrative seed cartridge 16 is shown in more detail. As shown, the seed cartridge 16 can include one or more seeds 110 located in or on a growing medium 194. The growing medium 194 can be supported within a frame 160 defining a lipped upper portion 173 and a lower portion 174 extending downward from the upper portion 173. According to the illustrative embodiment shown, the lower portion 174 can taper inwardly with increased distance from the upper portion 173, and can have a plurality of substantially vertical slits 303 extending through the lower portion 174, for example, to allow liquid or roots to pass through the frame 160. Alternatively, the lower portion 174 can have a substantially constant diameter such that it does not taper. A seal 172 or label can extend over the upper portion 174 of the frame 160, for example, to retain the growing medium 194 and/or seeds 110 in the seed frame 160. As shown, the seal 172 can include an aperture 30 therein, for example, to permit a plant, photoradiation, and/or liquid pass through the seal 172.

The seed cartridge 16 can be adapted for removable insertion into one of the receptacles 14 in the growing surface 8 of the appliance 2. For example, the lower portion 174 can have a diameter that passes through the receptacle 14, and the lipped upper portion 173 can have a diameter that is larger than the receptacle, such that the lip supports the seed cartridge 16 within the receptacle 14. According to an illustrative embodiment, the lower portion 174 can have a length (e.g. in the vertical direction) that is sufficiently long for all or a portion of the growing medium 194 to contact the liquid contained within the vessel 6 when the liquid is filled to at least the minimum liquid level, described above. One of ordinary skill in the art will appreciate that other structures besides the lipped upper portion 173 can be implemented to mount the seed cartridge 16 in one of the receptacles 14, such as mating snaps, ridges, or other structures.

According to an illustrative embodiment, the seed cartridge 16 can be dry and storable without germination of the seed(s) 110 until liquid is supplied to the seed(s) 110, for example, by the appliance 2. In an illustrative embodiment, the seed cartridge 16 can be sold in a partially or wholly disassembled state, with instructions to the user for putting the parts together. In an illustrative embodiment, the frame 160 can be separated into multiple components, for example, to facilitate removal of the growing medium 194 and/or plant for re-planting.

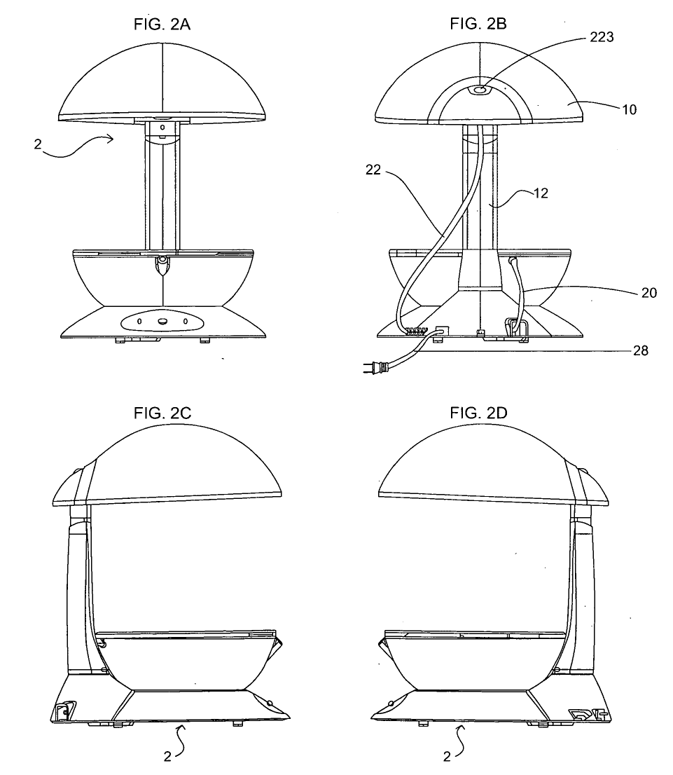

FIG. 2A depicts an illustrative front view of the appliance 2 of FIG. 1A. FIG. 2B depicts an illustrative rear view of the appliance 2, showing the conduit 20, electrical conduit 22, and power cord 28. The photoradiation hood 10 and an illustrative detent button 223 for adjusting the height of the support arm 12 and photoradiation hood 10 are also shown. FIGS. 2C and 2D are illustrative side views of the appliance 2.

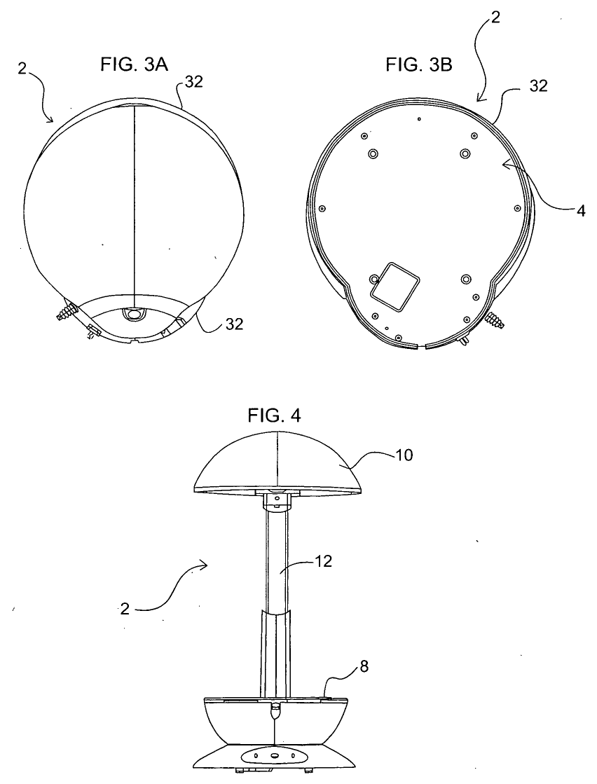

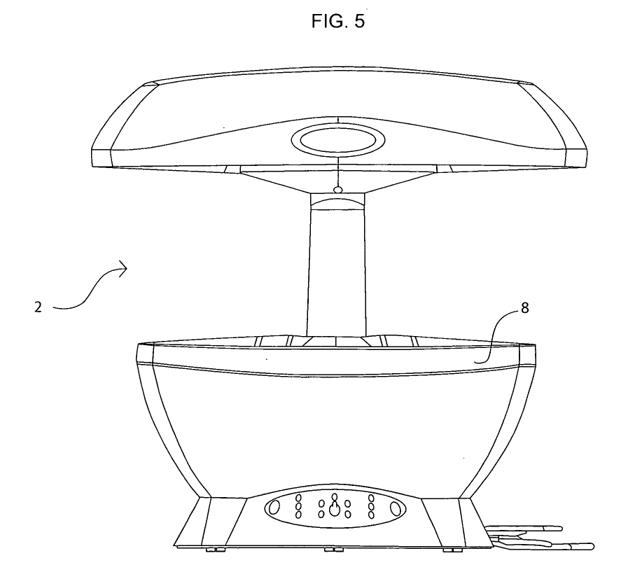

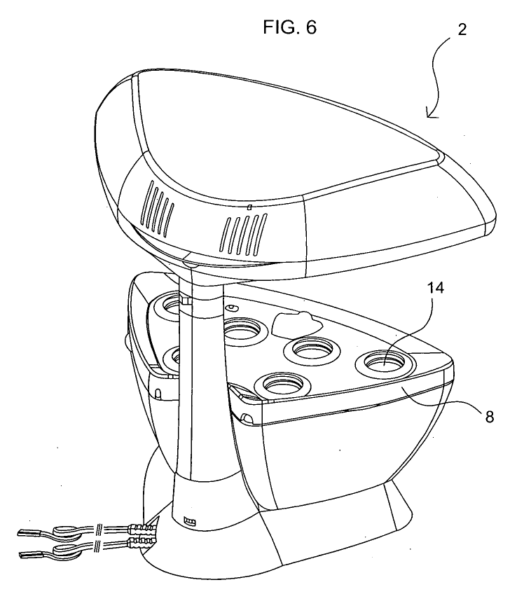

FIGS. 3A and 3B are illustrative top and bottom views, respectively, of the appliance 2 of FIG. 1A. As shown in FIG. 3B, the bottom surface of the base 4 can define a horizontal footprint 32 that supports the appliance 2 on a surface. The footprint 32 can be defined, for example, by the outermost perimeter of the base 4. According to an illustrative embodiment, the footprint 32 can be dimensioned to fully fit on a conventional kitchen countertop. For example, according to an illustrative embodiment, the footprint 32 can define a surface area of 500 square inches or less. According to another illustrative embodiment, the footprint 32 can define a surface area of 150 square inches or less.

FIG. 5A depicts an illustrative front view of the appliance 2, shown with the support arm 12 in an extended position compared to FIG. 1A, for example, to raise the height of the photoradiation hood 10 with respect to the growing surface 8. According to the illustrative embodiment shown, the support arm 12 can comprise a telescoping structure having a detent mechanism 223 (shown in FIG. 2B) that permits raising or lowering of the photoradiation hood 10. One of ordinary skill in the art will understand, however, that other structures known in the art can be implemented to facilitate extension and/or retraction of the support arm 12.

FIGS. 5 and 6 depict a front view and a rear perspective view, respectively, of an illustrative appliance 2 according to the present invention, which has six receptacles 14. Aside from the number of receptacles 14, appliance 2 is functionally similar to the appliance 2 shown in FIG. 1A, unless indicated otherwise herein.

FIGS. 7A and 7B depict a front perspective view and a front view, respectively, of an illustrative appliance 2 according to the present invention, which has six receptacles 14. Aside from the number of receptacles 14, appliance 2 is functionally similar to the appliance 2 shown in FIG. 1A, unless indicated otherwise herein.

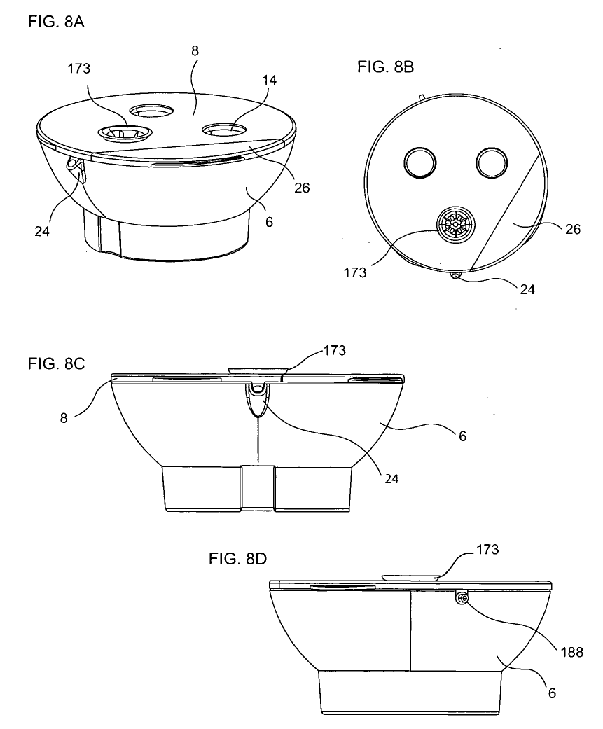

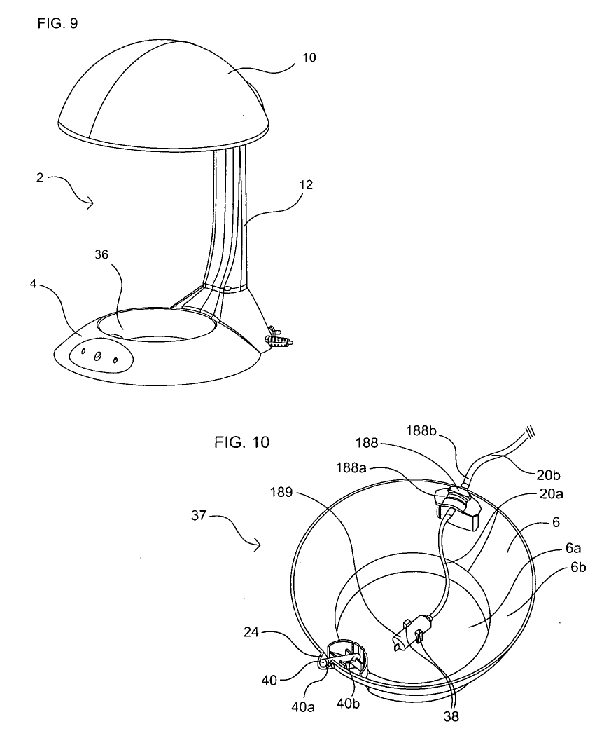

FIG. 8A depicts an illustrative front perspective view of the vessel 6 removed from the base 4. As shown, the vessel 6 can include a support portion 34 that can mate with a corresponding support portion 36 on the base 4 (see FIG. 9) such that the vessel 6 can be removably supported by the base 4. In the illustrative embodiment shown, the support portion 34 on the vessel 6 comprises a projection, and the support portion 36 on the base 4 comprises a recess for the projection, however, the opposite arrangement is also possible, as well as other mating configurations known in the art.

As shown in FIG. 8A, the growing surface 8 can have three apertures 14 adapted to support the upper portion 173 of the seed cartridge. FIGS. 8B-8D are illustrative top, front, and back views of the vessel 6. The door 26 can be used to add liquid to the vessel 4, to add nutrients, to view the plant roots, and/or to remove the growing surface 8, etc. In the illustrative embodiment of FIGS. 8A-8D, the liquid level gauge 24 comprises a prism that turns red when the liquid level gets below the minimum liquid level, as will be described in more detail below. However, alternative embodiments of the liquid level gauge are also contemplated, as will be described in more detail below. FIG. 8D depicts an illustrative embodiment of a one-way valve 188 located in a sidewall of the vessel 6, which will be described in more detail below.

FIG. 9 is an illustrative perspective view of the base 4, support arm 12, and photoradiation hood 10, shown with the vessel 6 removed from the base 4 to show the support portion 36 on the base 4.

FIG. 10 is an illustrative perspective view of the inside of the vessel 6, seen through the open upper portion 36 of the vessel 6. A gas diffuser 189, such as, for example, an air diffusing stone can be located inside the vessel 6. In the illustrative embodiment shown, the gas diffuser 189 is mounted on a bottom wall 6a of the vessel 6, for example, by brackets 38, however, other configurations and locations of the gas diffuser 189 are possible, as will be described in more detail below.

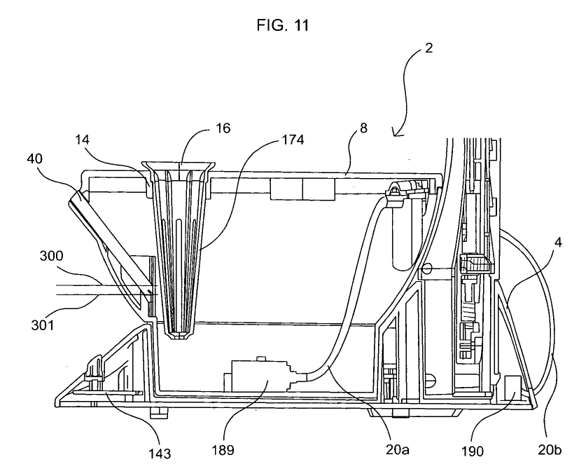

Still referring to FIG. 10, conduit 20 can connect the gas diffuser 189 to a pump located, for example, in the base 4 (see FIG. 11). The pump can pump air through the conduit 20 to the gas diffuser 189 in the vessel 6, where the gas diffuser 189 can create aerating bubbles in the liquid contained in the vessel 6. The aerating bubbles created by the gas diffuser 189 can help promote germination and/or growth of the seeds or plants supported in the receptacles 14 in the growing surface 8. The conduit 20 can comprise a flexible tube, such as silicon tubing, or other known type of tubing. The conduit 20 can include a first portion 20a located inside the vessel 6 that connects to the gas diffuser 189. The conduit can also include a second portion 20b, located outside of the vessel 6, that connects to the pump.

According to an illustrative embodiment, the first portion 20a and second portion 20b of the conduit 20 can comprise a single member that extends, for example, through an aperture in the vessel 6 or growing surface 8. Alternatively, the first portion 20a and second portion 20b of the conduit 20 can be separate parts that connect together, for example, on a portion of the vessel 6 or growing surface 8.

In the illustrative embodiment shown in FIG. 10, the first portion 20a and the second portion 20b of the conduit 20 are separate pieces of tubing that interconnect to one another at a one-way valve 188 located in a sidewall 6b of the vessel 6. The one-way valve 188 can prevent fluid-flow in the direction from inside the vessel 6 to outside the vessel 6, for example, to prevent the liquid contained in the vessel 6 from flowing through the conduit 20 to the pump. In the illustrative embodiment shown in FIG. 10, the one-way valve 188 can comprise a first portion 188a located inside the vessel 6, which is attached to the first portion 20a of the conduit 20, and a second portion 188b located outside the vessel 6, which is attached to the second portion 20b of the conduit 20, although other configurations are possible. The one-way valve 188 can comprise a ball check valve, a diaphragm check valve, a swing check valve, a clapper valve, or other type of valve known in the art.

Still referring to FIG. 10, the liquid level gauge 24 can comprise a prism 40 mounted, for example, to the sidewall 6b of the vessel 6 via brackets 42 or other structures. The prism 40 can have an upper end 40a that is located exterior to the vessel 6, and a lower end 40b that is concealed within the vessel 6. The upper end 40a of the prism 40 can be adapted to change color when little or none of the lower end 40b of the prism 40 is in contact with liquid, thereby indicating that the liquid in the vessel 6 has fallen below the minimum liquid level. According to the illustrative embodiment shown, a barrier wall 44 can be located at least partially around the prism 40, for example, to help prevent roots, algae, minerals, or other undesirable substances from interfering with the prism 40.

FIG. 11 depicts an illustrative side sectional view of a lower portion of the appliance 2 of FIG. 1A. As shown, the pump 190 can be located inside the base 4, and can have its outlet connected to the second portion of the conduit 20b, either directly or indirectly. According to an illustrative embodiment, the pump 190 can comprise a one-way diaphragm pump or a solenoid pump, however, other configurations are possible. FIG. 11 also depicts the controller 143 located inside the base 4. The controller 143 can comprise a programmable circuit board, programmable logic controller, microcomputer, or other device known in the art.

As compared to other types of pumps known in the art, such as liquid pumps, the gas pump 190 can operate more quietly. Also, locating the gas pump 190 inside the base 4 instead of, for example, the vessel 6, the gas pump 190 can be isolated from liquids, algae, mineral deposits, and other substances that can adversely affect its performance.

FIG. 11 also depicts an illustrative relationship between the prism 40 and the lower portion 174 of the seed cartridge 16, when the seed cartridge 16 is fully inserted in a receptacle 14 of the growing surface 8. According to the illustrative embodiment, as the plants (not shown) use liquid in the appliance 2, and the liquid level decreases, the prism 40 begins to turn red when the liquid decreases to the level shown by line 300. As the liquid level continues to decrease, the redness shown on the prism 40 gradually increases, until it reaches a maximum redness when the liquid level reaches line 301. If the liquid level continues to drop below the level indicated by line 301, the prism 40 will continue to show the maximum red signal. Therefore, according to the illustrative embodiment shown, line 301 represents the minimum liquid level, however, other positions for the minimum liquid level are possible. As can be seen in FIG. 11, the lower portion 174 of the seed cartridge 16 extends below line 301, indicating that, according to this illustrative embodiment, the growing medium 194 and/or plant roots maintain contact with the liquid when the liquid is at or above the minimum liquid level.

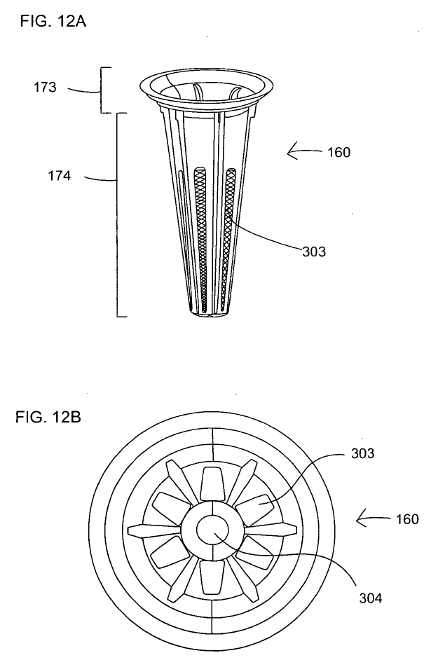

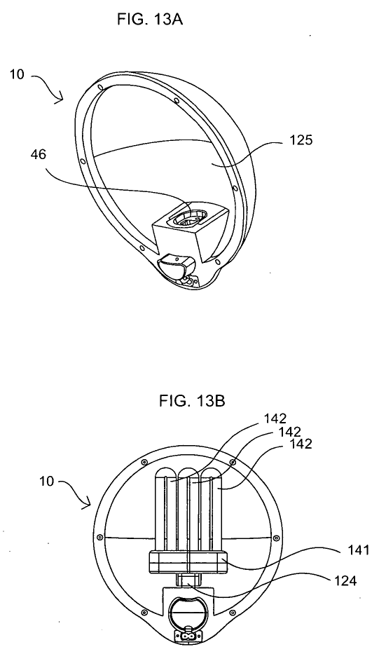

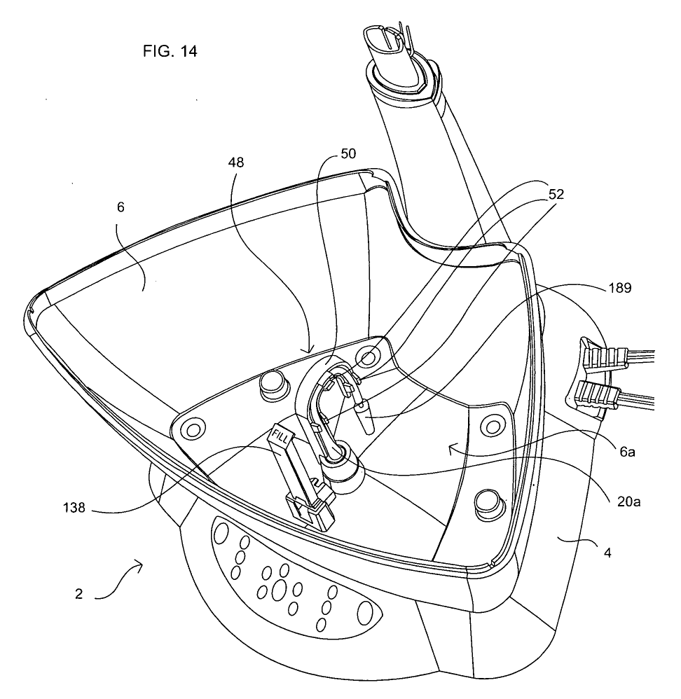

FIG. 12A is an illustrative perspective view of the frame 160 of the seed cartridge 16. The upper portion 173 and the lower portion 174 of the frame 160 are shown, along with the substantially vertical slits 303 in the lower portion 174. The increased diameter of the lipped upper portion 173 is also shown. FIG. 12B is an illustrative top view of the frame 160, showing substantially vertical slits 303, as well as a central aperture 304 in the bottom of the lower portion 174 of the frame 160.

FIG. 13A depicts an illustrative bottom perspective view of the photoradiation hood 10 of FIG. 1A, shown without light bulbs. As shown, the photoradiation hood 10 can be substantially dome-shaped, and can include a socket 46 for connection to one or more light bulbs. FIG. 13B is an illustrative bottom view of the photoradiation hood 10, shown with a light bulb 124 plugged into the socket 46. As shown, the bulb 124 can comprise a support base 141, and one or more U-shaped tubular portions 142, however, other configurations are possible. In an illustrative embodiment, the support base 141 can comprise a ballast, and in another illustrative embodiment, the photoradiation hood 10 can comprise the ballast. Light bulbs that produce high quantities and qualities of light and low amounts of heat can be useful in the practice of this invention. For example, exemplary light bulbs can include fluorescent bulbs, incandescent bulbs, high-intensity discharge lamps, high pressure sodium bulbs, metal halide lamps, light-emitting-diodes, as well as other types of artificial light sources known in the art. A reflective layer 125, such as polished aluminum, can be located on the underside of the photoradiation hood 10, for example, to reflect light emitted from the light bulb(s) 124 toward the growing surface 8 (shown in FIG. 1A).

FIG. 14 is an illustrative perspective view of a base 4 and vessel 6 of the garden 2 shown in FIGS. 5 and 6. According to this illustrative embodiment, an inverted p-trap 48 can be in fluid communication with the gas diffuser 189. According to the illustrative embodiment shown, the inverted p-trap 48 can be located upstream from the gas diffuser 188 in order to resist liquid from the vessel 6 entering the first portion 20a of the conduit 20. Due to the shape of the inverted p-trap 48, gravity forces tend to prevent the liquid in the vessel 6 from flowing from the vessel 6 into the first portion 20a of the conduit 20. According to the illustrative embodiment shown, the inverted p-trap 48 comprises an upside-down, approximately 180 degree U-shaped bend in the first portion 20a of the conduit 20, however, other configurations are possible. A conduit support member 50 can be provided in the vessel 6 to retain at least a portion of the first portion 20a of the conduit 20 in the inverted position. The conduit support member 50 can comprise plastic or other material that extends upward from the bottom surface 6a of the vessel 6 and has clips 52 or other structures that retain the first portion 20a of the conduit 20, although other configurations are possible.

Still referring to FIG. 14, the appliance 2 can include a maximum liquid level tab 138, which, in the illustrative embodiment shown, comprises a post extending upward from the bottom surface 6a of the vessel 6. Alternatively, the maximum liquid level tab 138 can comprise an inverted post that hangs down from the underside of the growing surface (not shown), or another configuration known in the art.

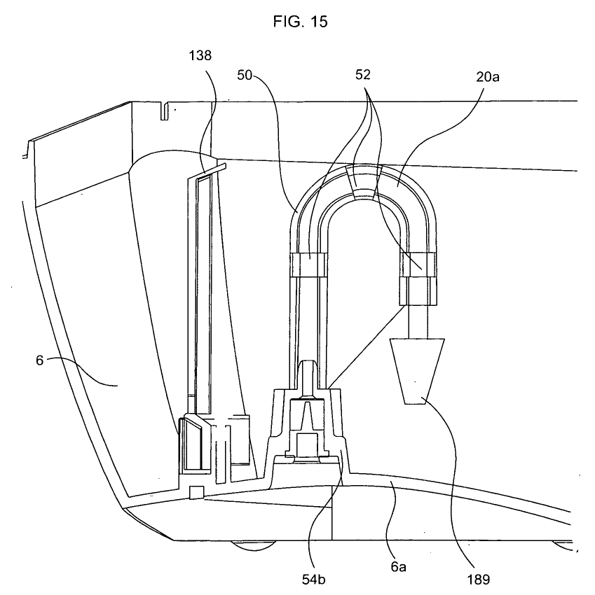

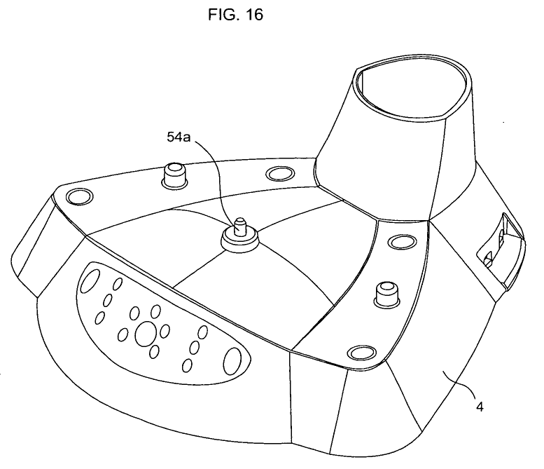

FIG. 15 is an illustrative, perspective sectional view of the vessel 6 of FIG. 14, shown removed from the base 4. FIG. 15 depicts the illustrative inverted p-trap 48 and maximum liquid level tab 138, along with their related details. In addition, FIG. 15 depicts an illustrative fluid coupling 54 according to the present invention. The fluid coupling 54 can operate, for example, to connect (and disconnect) the first portion 20a of the conduit 20 with the second portion 20b of the conduit 20. Referring to FIGS. 15 and 16, the fluid coupling 54 can comprise a first portion 54a located on the base 4, and a second portion 54b located on the bottom wall 6a of the vessel 6. The first portion 54a and second portion 54b of the fluid coupling 54 can be configured and dimensioned to connect with one another when the vessel 6 is placed in its intended position on the base 4. Removal of the vessel 6 from the base 4, however, can cause the first portion 54a and the second portion 54b of the fluid coupling 54 to disconnect from one another, thereby disconnecting the first portion 20a and the second portion 20b of the conduit 20 from one another.

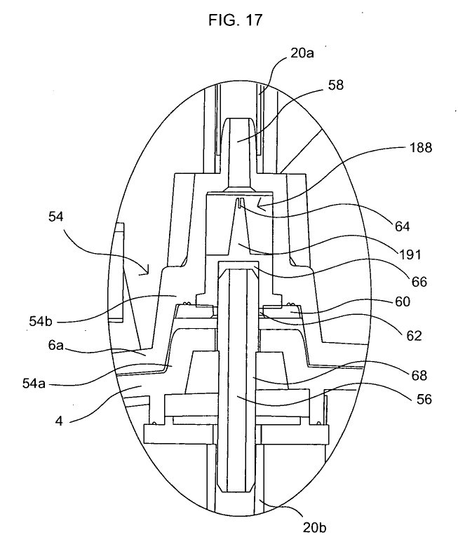

FIG. 17 is an enlarged, partial sectional view of the fluid coupling 54, showing the details of the first portion 54a and the second portion 54b connected together. As shown, the first portion 54a can comprise a protrusion that extends upward from the base 4, and the second portion 54b can comprise a recess in the bottom wall 6a of the vessel 6, which can receive the protrusion in a substantially air-tight manner. Alternatively, the opposite arrangement is possible, where the first portion 54a comprises a recess and the second portion 54b comprises a protrusion.

Still referring to FIG. 17, a one-way valve 188 can be located in the second portion 54b of the fluid coupling 54. For example, in the illustrative embodiment shown, the one-way valve 188 can be located in the recess that defines the second portion 54b of the fluid coupling, however, other configurations are possible. The one-way valve can function to prevent liquid in the vessel 6 from accidentally leaking out through the second portion 54b of the fluid coupling 54 when the vessel 6 is removed from the base 4, as will be discussed in more detail below.

The first portion 54a of the fluid coupling 54 can include an inlet 56 that is in fluid communication with the second portion 20b of the conduit 20. Similarly, the second portion 54b of the fluid coupling can include an outlet 58 that is in fluid communication with the first portion 20a of the conduit 20. The one-way valve 188 can be retained in the recess in the bottom wall 6a of the vessel 6, for example, by a retainer wall 60 having an aperture 62.

In the illustrative embodiment shown, the one-way valve 188 can comprise a substantially cone-shaped elastic membrane 191 having a slit 64 along the upper edge of the cone. The lower portion of the cone-shaped elastic membrane 191 can include a seat 66 that receives the upper end of the inlet 56 in an air-tight fashion when the vessel 6 is supported on the base 4. The elastic nature of the membrane 191 can naturally bias the slit 64 toward a sealed position, such that any liquid dripping from the outlet 58 onto the membrane 191 does not penetrate the slit 64, but rather, runs down the inclined sides of the membrane 191 and is thereby prevented from flowing through the fluid coupling 54 into the second portion 20b of the conduit 20. Additionally, in the event that liquid runs through the outlet 58 onto the membrane 191, the pressure of the liquid against the inclined sides of the membrane can bias the slit 64 closed, thereby improving the strength of the seal.

When the pump (not shown) is activated, it supplies pressure through the second portion 20b of the conduit 20, which in turn, applies air pressure against the internal surfaces of the membrane 191. This pressure can cause the slit 64 along the upper edge of the membrane 191 to open, thereby allowing airflow from the second conduit portion 20b to the first conduit portion 20a through the fluid coupling 54. Once the pump (not shown) is turned off, the air pressure against the membrane 191 ceases, and the slit 64 can close under the elastic force of the membrane 191. One of ordinary skill in the art will appreciate that the present invention is not limited to the specifics of the fluid coupling 54 and one-way valve 188 described herein, and that other configurations are possible. For example, according to an alternative embodiment, the one-way valve 188 can comprise a ball check valve, a diaphragm check valve, a swing check valve, a clapper valve, or other type of valve known in the art.

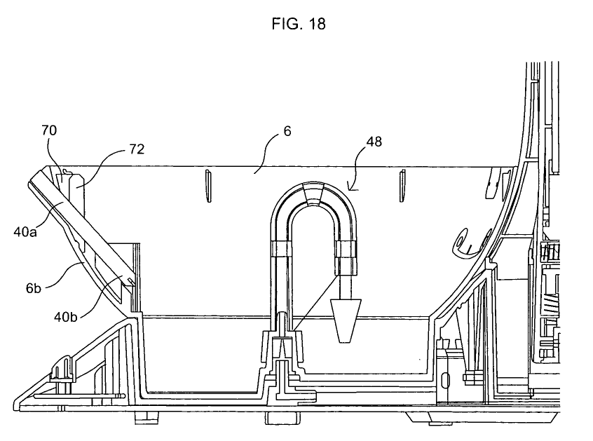

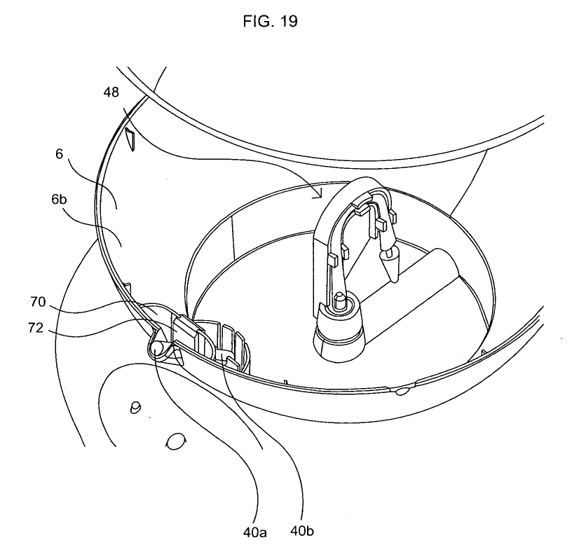

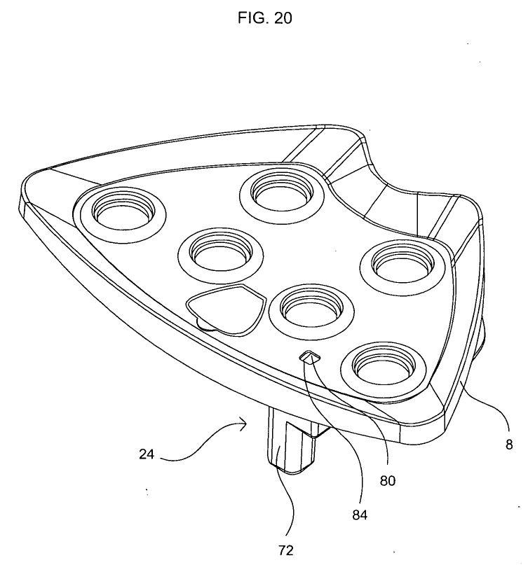

Referring to FIGS. 18 and 19, an alternative embodiment of the appliance 2 of FIG. 1A is shown, which can include an inverted p-trap 48 and fluid coupling 54 similar to those shown and described in connection with FIGS. 14-17. Additionally or alternatively, the appliance 2 can include a partition wall 70 that extends from the sidewall 6b of the vessel 6 and defines a substantially water-tight enclosure separate from the rest of the interior of the vessel 6. The upper portion 40a of the prism 40 can be located in the substantially water-tight enclosure, for example, to prevent algae, fungus, or mineral deposits from forming on the prism. The lower portion 40b of the prism 40 can extend through the partition wall 70, and into the lower portion of the vessel 6, allowing the lower portion 40b of the prism to contact the liquid in the vessel 6, when present. According to an illustrative embodiment, the prism 40 can extend through an aperture in the partition wall 70, for example, formed in a rubber portion 72 of the partition wall 70, although other configurations are possible. The rubber portion 72 of the partition wall 70, if provided, can facilitate easy removal and replacement of the prism 40, for example, to facilitate cleaning.

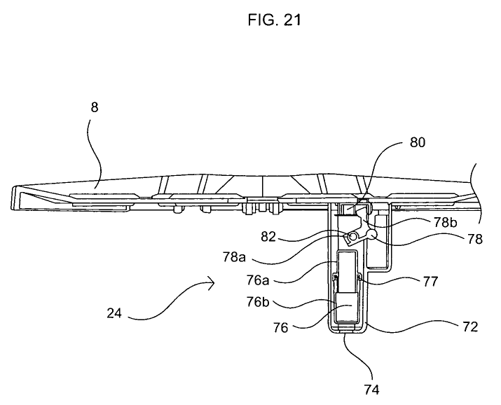

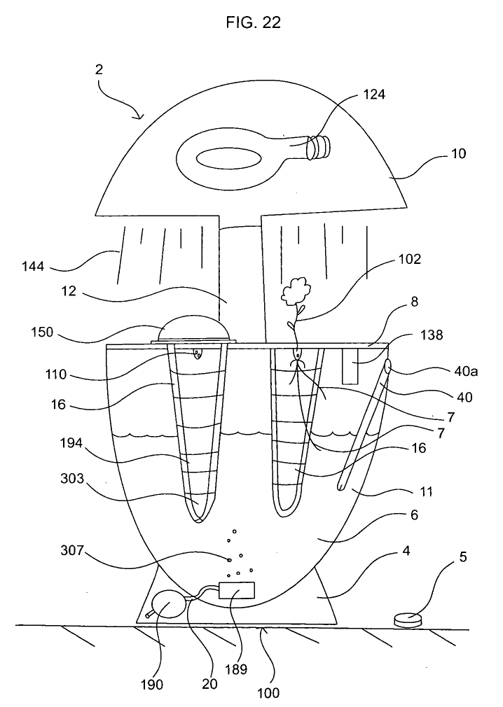

FIGS. 20 and 21 depict an alternative embodiment of a liquid level gauge 24 according to the present invention, shown for illustrative purposes in connection with the growing surface 8 of FIGS. 5 and 6. According to the illustrative embodiment shown in FIGS. 21 and 22, the liquid level gauge 24 can comprise a chamber 72 having a fixed position with respect to the vessel (not shown), for example, the chamber 72 can be fixed to the underside of the growing surface 8. As shown in FIG. 21, the chamber 72 can have at least one aperture 74 in fluid communication with the liquid in the vessel (not shown). The aperture 74 can allow liquid in the lower portion of the vessel (not shown) to enter the inside of the chamber 72.

Still referring to FIG. 21, the liquid level gauge 24 can also include a float 76 movable (e.g., up and down) in the chamber 72 based on the liquid level within the vessel (not shown). The liquid level gauge 24 can also include a pivoting member 78 pivotably fixed within the chamber 72. The pivoting member 78 can have a first pivot arm 78a located in contact with the float 76, and a second pivot arm 78b engaged with a sliding member 80. The first pivot arm 78a can support a counterweight 82, such as a ball bearing or other dense structure, that causes the first pivot arm 78a to rest atop the float 76. The first pivot arm 78a and the second pivot arm 78b can be angled with respect to another, for example, by approximately 90 degrees, such that movement of the float 76 up or down (e.g., in response to changes in the liquid level) translates into sliding of the sliding member 80 to the left or right. As shown in FIG. 21, the float 76 can comprise an upper hollow portion 76a and a lower hollow portion 76b sealed together, for example, by an o-ring 77 located at the junction of the upper hollow portion 76a and the lower hollow portion 76b, however, other configurations are possible.

Referring to FIG. 21, the sliding member 80 can be located beneath a window 84 in the growing surface 8. The window 84 can comprise, for example, an opening in the growing surface 8, or alternatively, a transparent or translucent portion of the growing surface 8. Accordingly, the sliding member 80 can be seen through the window 84. The sliding member 80 can include liquid level indicia (not labeled) visible through the window 84, such that the level of liquid in the vessel (not shown) can be observed by the indicia (not labeled) showing through the window 84 in the growing surface 8.

According to another illustrative embodiment, not shown, the liquid level gauge 24 can comprise a float located within a substantially linear housing attached to the vessel 6, for example, to the bottom surface 6a of the vessel 6. The float can include a metallic portion or a magnetic portion. The float can rise and fall with the level of the liquid in the vessel 6. One or more sensors, such as a linear hall effect sensor, can be located near the substantially linear housing, and can detect the height of the float by sensing the magnetic field from the metallic or magnetic portion. Alternative embodiments of the liquid level gauge 24 can include a float connected to a mechanical encoder, a float connected to an optical encoder, an infrared device, a magnetic floatation device in combination with a magnetic reed switch, electric current devices, proximity switch devices, infrared devices, sonic devices, photocell devices, and photographic devices. Additional information relating to liquid level gauges can be found in co-pending U.S. patent application Ser. No. 12/002,543, filed on Dec. 17, 2007, the entire content of which is incorporated herein by reference.

An illustrative use of the indoor gardening appliances of the present invention will now be described in connection with FIG. 22, which depicts an illustrative countertop gardening appliance 2 according to the present invention. As described previously, the appliance 2 can have a base 4 sized and dimensioned to allow the user to place the appliance 2 on a conventional kitchen countertop 100. The photoradiation hood 10 can be attached to the base 4 by the support arm 12, which as described above, can be adjusted in length by the user. When the vessel 6 is placed onto the base 4, a fluid coupling (not shown) can create a fluid passageway between the pump 190 located in the base 4, and the gas diffuser 189 located in the vessel. Seed cartridges 16 can be removably inserted into receptacles 14 in the growing surface 8. Photoradiation 144 emitted from the bulb(s) 124 in the photoradiation hood 10 shines down on the plant 102 and/or seeds 110. The plant 102 and/or seeds 110 can receive liquid 11 from the lower portion of the vessel 6, for example, through the growing medium 194 within the seed cartridges 16, because the growing medium extends into the liquid 11 and is hydrophilic. The liquid 11 can comprise, for example, water with dissolved nutrients. The plant 102 may grow roots 7 through substantially vertical slits 303 in the lower portion 174 of the seed cartridge 16.

The appliance 2 can deliver oxygen from the gas pump 190 located in base 4, for example, through the conduit 20 that connects to the gas diffuser 189 via a one-way valve (not shown). The gas diffuser 189 can emit tiny bubbles 307, which contain oxygen gas, into the liquid 11. Due to the high surface area of the tiny bubbles 307, the oxygen gas easily dissolves into the liquid 11 for uptake by the plant 102 through its roots 7. According to an illustrative embodiment, the gas emitted from the gas diffuser 189 can maintain or increase the level of dissolved oxygen in the liquid 11.

When liquid is introduced into the vessel 6, it can be added to a level below the maximum liquid level indicated by the maximum liquid level tab 138, which in the illustrative embodiment shown, hangs from an underside of the growing surface 8. The liquid level gauge, shown in FIG. 22 as a prism 40, includes an upper end 40a that looks black on the outside of the appliance 2 when the liquid level is above the minimum liquid level, and gradually turns redder as the liquid level approaches, or falls below, the minimum liquid level. The red color of the prism 40 can serve as an add liquid indicator to the user, who can refill the vessel 6 with liquid.

The growing medium 194 can be formed to fill substantially the entire lower portion 174 of the seed cartridge 16, and can have a composition that wicks liquid and a nutrient dose 5 dissolved in the liquid 11 up to the seed 110 or plant 102 near the upper portion 173 of the seed cartridge 16. During germination of the seed 110, the seed cartridge 16 can be covered by a germination cap 150. The cap can be removed after the seed 110 germinates, when the cap is no longer needed for regulating humidity and/or temperature. When the plant 102 grows tall enough, the adjustable arm 12 can be used to raise the light hood 10 to keep the bulb 124 at least about one to two inches above the highest part of the plant 102.

A controller, not shown, can be located within the base 4, and can operate the pump 190 on a timed on/off cycle. Additionally or alternatively, the controller can operate the light bulb 124 on a timed on/off cycle, which can be the same as, or different from, the timed on/off cycle for the pump 190.

According to an illustrative embodiment, the liquid contained in the vessel 6 can be water or water with dissolved plant nutrients. According to an illustrative embodiment, the plant nutrients can be combined with human nutrients, causing edible plants grown in the appliance 2 to be more nutritious for humans.

According to an illustrative embodiment, the minimum liquid level can be located far enough away by volume of water from the lowermost portion of the growing medium 194, so that the growing medium 194 is unlikely to dry out before a user of the appliance 2 notices that the liquid level is below the minimum liquid level. According to an illustrative embodiment, the seed cartridge 16 supports a live plant and is kept wet with the liquid to keep the plant alive until the seed cartridge 16 is placed in the appliance 2. According to an illustrative embodiment, the frame 160 of the seed cartridge 16 can comprise a net basket. According to an illustrative embodiment, the frame 160 of the seed cartridge 16 can function as the growing medium 194. According to another illustrative embodiment, the growing medium 194 can function as the frame 160 of the seed cartridge 16.

According to an illustrative embodiment, the controller 143 can comprise a timer adapted to turn the pump 190 on for twenty second intervals and off for forty second intervals. In an illustrative embodiment, the pump 190 can be turned on for about one-third of the growing time, or at least about fifteen seconds of every minute. According to an illustrative embodiment, the pump 190 can be turned on and off often enough to provide a movement current in the liquid, to promote growth of strong plant roots.

According to an illustrative embodiment, the controller 143 can turn the light bulb(s) 124 on for a time between about fifteen and about twenty-four hours, and off for a time between about zero and about nine hours, out of every twenty-four hour period. According to an illustrative embodiment, the controller 143 can turn the pump 190 on for a time between about five seconds and about sixty seconds, and off for a time between about zero seconds and about fifty-five seconds, out of every one minute period. In another illustrative embodiment, the pump 190 can be turned on for about twenty seconds and off for about forty seconds. According to an illustrative embodiment, the pump 190 can be turned on for twenty four hours a day (i.e., constantly on) and/or the light bulb(s) 124 can be turned on for twenty four hours a day (i.e., constantly on). This may facilitate use of, for example, an external timing system.

In an illustrative embodiment, the controller 143 can comprise a timer adapted to turn the light bulb(s) 124 on and off in predetermined cycles. In an illustrative embodiment, the control panel 18 can include an add-nutrient indicator, a change-bulb indicator, a reset mechanism, and/or a toggle switch for turning the light bulb(s) 124 on and off. In an illustrative embodiment, the controller 143 can include one or more predetermined time cycles for the light bulb(s) 124 and the pump 190. According to another illustrative embodiment, the controller 143 can be programmable by the user, for example, to set the time cycles for the light bulb(s) 124 and/or the pump 190. According to another illustrative embodiment, the controller 143 can be connected to an external data source, such as an external programmable storage device or the internet, for example, to download timing cycles for the pump 190 and/or light bulb(s) 124.

According to an illustrative embodiment, the appliance 2 can be part of a system including a complete set of plant nutrients. The nutrients can be provided in pre-measured doses, such as tablets, for delivery at about one to four week intervals. The system can include a sufficient quantity of the nutrients to last an entire growing season for plants germinated from the seed cartridges 16. For example, a set of plant nutrients can comprise from about three to about fifteen doses, wherein each dose comprises about 0.25 grams to about five grams of plant nutrients. In an illustrative embodiment, the complete set of plant nutrients can include doses with different quantities and qualities of plant nutrients designed for different stages of plant growth. For example, the early doses can have relatively less nutrient, and the later doses can have relatively more calcium and magnesium.

According to an illustrative embodiment, the seeds 110 can comprise vegetable seeds, fruit seeds, herb seeds, and flower seeds. Many seeds and plants may be useful in the practice of this invention, including culinary herbs, miniature fruit and vegetable plants, miniature roses, and hard-to-grow plants such as orchids.

In an illustrative embodiment, the vessel 6 can hold between about two cups and about two gallons of liquid. In an illustrative embodiment, the vessel 6 can contain between about five cups and about one gallon, or between about three cups and about five cups, or between about five cups and seven cups. In an illustrative embodiment, the appliance 2 can further include an add nutrient gauge indicating how much and/or when to add nutrients. The add nutrient gauge can be controlled, for example, by the controller 143.

The appliance 2 according to the present invention can be useful for growing plants from seed through harvest, and through senescence or death. The appliance 2 can be used for growing, for example, transplants, cuttings, somatic embryos, tubers, and runners.

Various components of the appliance 2 according to the present invention can be made by injection molding ABS plastic. However, the appliance 2 can be made from any material that is firm enough to hold liquid, and does not substantially hinder plant growth. For example, materials useful in the practice of this invention include, for example, glasses, plastics, and metals. Useful plastics can include, for example, acrylonitrile butadiene styrene, polyethylene terepthalate glycol, polystyrene, polycarbonate, as well as recycled, recyclable, photodegradable, and biodegradable plastics. According to an illustrative embodiment, biodegradable plastic materials can be used for the frames 160 of the seed cartridges 16, which may be transplanted into the ground. According to an illustrative embodiment, the material used to make the growing surface 8 and vessel 6 are sufficiently impermeable to photoradiation to prevent photoradiation from entering inside the vessel 6.

According to an illustrative embodiment, a method of growing a plant using a countertop gardening appliance can comprise placing a base on a countertop, the base housing a gas pump and a controller; attaching a hood to the base with a support arm, the hood containing an artificial light source; placing a vessel on the base, the vessel defining a closed lower portion, and an open upper portion, wherein a gas diffuser is located in the vessel; adding a liquid to the closed lower portion of the vessel until the liquid reaches or exceeds a minimum liquid level indication on a liquid level gauge located in the vessel; placing a growing surface over the open upper portion of the vessel, the growing surface including a receptacle; inserting a seed cartridge into the receptacle until an upper portion of the seed cartridge contacts the growing surface and a growing medium located in a lower portion of the seed cartridge contacts the liquid in the closed lower portion of the vessel; pumping a gas from the gas pump through the gas diffuser through a conduit and a one-way valve in fluid communication with the conduit; and switching the artificial light source and the gas pump on and off based on predetermined timed cycles using the controller.

According to an illustrative embodiment, a user placing the vessel on the base can cause a first portion of the conduit in fluid communication with the gas pump to connect to a second portion of the conduit in fluid communication with the gas diffuser. According to an illustrative embodiment, the method can further comprise removing the vessel from the base, wherein the user removing the vessel from the base causes the first portion of the conduit to disconnect from the second portion of the conduit. For example, a user placing the vessel on the base can cause a recess in a bottom wall of the vessel to receive a protruding member extending from the base, the recess being in fluid communication with the second portion of the conduit, and the protrusion being in fluid communication with the first portion of the conduit.

According to an illustrative embodiment, the method can further comprise pumping the gas through an inverted p-trap in fluid communication with the gas diffuser. According to another illustrative embodiment, the method can further comprise removing the liquid level gauge from the vessel by sliding the liquid level gauge through a substantially water-tight seal; cleaning the liquid level gauge; and replacing the liquid level gauge in the vessel. For example, the liquid level gauge can comprise a prism having a portion extending through an aperture in a partition wall in the vessel; and removing the liquid level gauge can comprise removing the prism from the aperture in the partition wall in the vessel; and replacing the liquid level gauge can comprise inserting the prism into the aperture in the partition wall in the vessel.

Seed cartridges and other components useful in the practice of this invention can be found in U.S. Patent Application Publication Nos. 2005/0102895A1 and 2005/0257424A1. Nutrient compositions and other components useful in the practice of this invention can be found in U.S. Patent Application Publication Nos. 2006/0254332A1 and 2006/0272205A1. Smart garden devices and methods for growing plants and other components useful in the practice of this invention can be found in U.S. Patent Application Publication No. 2006/0272210A1. The foregoing references are hereby incorporated herein by reference to the extent that they are not inconsistent with the disclosure of the present application.

The embodiments illustrated and discussed in this specification are intended only to teach those skilled in the art the best way known to the inventors to make and use the invention. Nothing in this specification should be considered as limiting in scope. All examples presented are representative and non-limiting. The above-described embodiments may be modified or varied, as appreciated by those skilled in the art in light of the above teachings. It is therefore to be understood that, within the scope of the claims and their equivalents, the invention may be practiced otherwise than as specifically described.

What is claimed:

1. A countertop gardening appliance, comprising:
a base sized and dimensioned to fit on a countertop;
a vessel removably supported by the base, the vessel defining a closed lower portion for storing a liquid, and an open upper portion;
a gas diffuser located in the vessel;
a gas pump located within the base;
a conduit connecting the gas pump to the gas diffuser;
a one-way valve in fluid communication with the conduit;
a growing surface covering the open upper portion of the vessel, the growing surface including a receptacle adapted to receive a seed cartridge;
a liquid level gauge indicating a level of the liquid in the vessel;
a hood supported above the growing surface by a support arm connected to the base, the hood including an artificial light source; and
a controller located within the base, the controller adapted to activate the artificial light source and the gas pump on predetermined time cycles.

2. The countertop gardening appliance of claim 1, further comprising a fluid coupling in fluid communication with the conduit, the fluid coupling including a first portion located on the base and a second portion located on a bottom wall of the vessel, wherein the first portion of the fluid coupling and the second portion of the fluid coupling interconnect when the vessel is supported on the base, and the first portion of the fluid coupling and the second portion of the fluid coupling disconnect when the vessel is removed from the base.

3. The countertop gardening appliance of claim 2, wherein the first portion of the fluid coupling comprises a protruding member extending from the base, and the second portion of the fluid coupling comprises a recess in the bottom wall of the vessel adapted to receive the protruding member.

4. The countertop gardening appliance of claim 3, wherein the one-way valve is located in the recess in the bottom wall of the vessel.

5. The countertop gardening appliance of claim 1, wherein the gas diffuser comprises an air diffusing stone.

6. The countertop gardening appliance of claim 6, wherein the air diffusing stone is mounted on a bottom wall of the vessel.

7. The countertop gardening appliance of claim 1, further comprising an inverted p-trap in fluid communication with the gas diffuser.

8. The countertop gardening appliance of claim 7, wherein the inverted p-trap comprises a conduit support member located in the vessel, wherein the conduit support member retains at least a portion of the conduit in an inverted U-shaped configuration.

9. The countertop gardening appliance of claim 1, wherein the liquid level gauge comprises a prism mounted to a side wall of the vessel, the prism having an upper end located exterior to the vessel, and a lower end located proximate a minimum liquid level.

10. The countertop gardening appliance of claim 9, further comprising a partition wall located on the side wall of the vessel, the partition wall defining a substantially water-tight enclosure separate from the closed lower portion of the vessel, wherein a portion of the prism extends through the partition wall.

11. The countertop gardening appliance of claim 10, wherein the partition wall comprises a rubber portion defining an aperture, and the prism extends through the aperture.

12. The countertop gardening appliance of claim 1, wherein the liquid level gauge comprises:
a chamber having a fixed position within the vessel, the chamber having at least one aperture in fluid communication with the closed lower portion of the vessel;
a float movable within the chamber based on a liquid level within the vessel;
a pivoting member located within the chamber, the pivoting member having a first pivot arm and a second pivot arm angled with respect to one another, the first pivot arm located in contact with the float; and
a sliding member located in contact with the second pivot arm, the sliding member including a liquid level scale;
wherein movement of the float within the chamber causes pivoting of the pivoting member, and pivoting of the pivoting member causes sliding of the sliding member.

13. The countertop gardening appliance of claim 12, wherein the first pivot arm includes a counter weight.

14. The countertop gardening appliance of claim 12, wherein the liquid level gauge further comprises a window located exterior to the growing surface, wherein the liquid level scale is visible through the window.

15. The countertop gardening appliance of claim 1, wherein the base defines a horizontal footprint having a surface area of 500 square inches or less.

16. The countertop gardening appliance of claim 1, wherein the base defines a horizontal footprint having a surface area of 150 square inches or less.

17. The countertop gardening appliance of claim 1, further comprising:
a seed cartridge adapted for removable insertion into the receptacle, the seed cartridge including an upper portion supported by the growing surface, and a lower portion extending downward into the vessel.

18. The countertop gardening appliance of claim 17, wherein the seed cartridge includes a growing medium and a seed supported by the growing medium.

19. The countertop gardening appliance of claim 17, wherein the liquid level gauge includes an indication for a minimum liquid level, and the lower portion of the seed cartridge extends downward into the vessel below the minimum liquid level.

20. A countertop gardening appliance, comprising:
a base sized and dimensioned to fit on a countertop;
a vessel removably supported by the base, the vessel defining a closed lower portion for storing a liquid, and an open upper portion;
a gas diffuser located in the vessel;
a gas pump located within the base;
a conduit connecting the gas pump to the gas diffuser;
a growing surface covering the open upper portion of the vessel, the growing surface including a receptacle adapted to receive a seed cartridge; and
a fluid coupling in fluid communication with the conduit, the fluid coupling including a first portion located on the base and a second portion located on a bottom wall of the vessel, wherein the first portion of the fluid coupling and the second portion of the fluid coupling interconnect when the vessel is supported on the base, and the first portion of the fluid coupling and the second portion of the fluid coupling disconnect when the vessel is removed from the base.
